(19) United States
(12) Patent Application Publication
(10) Pub. No.: US 2009/0122127 A1
(43) Pub. Date: May 14, 2009

(54) INKJET RECEIVER

(76) Inventor: Julie Baker, Hertfordshire (GB)

Correspondence Address: EASTMAN KODAK COMPANY;PATENT LEGAL STAFF, 343 STATE STREET, ROCHESTER, NY, 14650-2201, US

(21) Appl. No.: 12/280,862

(22) PCT Filed: Jan. 30, 2007
(86) PCT No.: PCT/GB2007/000296

§ 371 Date: Aug. 27, 2008

(30) Foreign Application Priority Data
Feb. 28, 2006 (GB) 0604020.8

(51) Int. Cl. B41J 3/407

(52) U.S. Cl. 347/106

(57) ABSTRACT

An inkjet receiver having upon a support an ink-receiving pack which comprises an image-receiving layer of a binder and 0.5 to 10 g/m² of an inorganic particulate material, of which at least 70% by weight is alumina, and an second layer of a binder and 10 to 40 g/m² of an inorganic particulate material, of which at least 65% is fumed silica and/or silica gel, and an optional third layer having up to 30 g/m² of an inorganic particulate that is mostly calcium carbonate, the receiver demonstrating excellent printing properties, gloss and absorption rate, whilst being relatively economical and simple to manufacture. Optional inclusion of mordant in the image-receiving layer provides an effective universal glossy receiver.

### FIELD OF THE INVENTION

The present invention relates to the field of inkjet printing and to inkjet applications requiring a porous inkjet receiver. More particularly, the present invention relates to a porous inkjet receiver, especially for use with pigmented inks, but optionally also with dye-based inks, having improved manufacturability and lower cost while maintaining beneficial imaging properties, and to a method of making such a receiver.

### BACKGROUND OF THE INVENTION

Inkjet receivers are generally classified in one of two categories according to whether the principal component material forms a layer that is “porous” or “non-porous” in nature. Some commercial photo-quality porous receivers are made using a relatively low level of a polymeric binder to lightly bind inorganic particles of alumina together to create a network of interstitial pores which absorb ink by capillary action. In order to achieve the required gloss, ink absorption rate and capacity, these alumina receivers or similar have to be very thick, which can lead to high cost and difficulty in manufacturing, with problems such as cracking.

Several other formulations of inkjet receivers have been proposed in seeking to provide glossy, fast drying, porous inkjet receivers.

U.S. Pat. No. 6,872,430 (Burch et al) is concerned with a porous inkjet receiver with a binder gradient. It describes an inkjet receiver having an ink-receiving layer with at least an upper and a lower portion through which the binder and/or the pigment is the same, but which differ in that there is a higher binder to pigment ratio in the lower portion than in the upper portion. The pigment in the ink-receiving layer is said to preferably be an alumina pigment or a silica pigment. Optionally, there is a top layer for providing scratch resistance, which is preferably different from the pigment of the ink-receiving layer and is preferably silica. The formulation is said to provide an inkjet receiver with good adhesion to the substrate, good manufacturability at high coat weights, good image quality and good ink absorption, without needing a large raw material set and complicated mixing processes.

U.S. Pat. No. 6,855,382 (Barkcock et al) describes a porous inkjet recording material having a lower and an upper pigment-containing layer in which the pigment in the upper layer is present in at least two particle size distributions, one in the range of 10 to 100 nm and the other in the range 1000 to 3000 nm, and wherein the pigment in the upper layer is different from the pigment in the lower layer. This formulation is said to provide a receiver with universal usability with different inkjet printers in that it is receptive to inks containing dyes and inks containing pigments. The pigment of the upper layer may be one of several pigments, but is preferably an alumina, such as amorphous alumina, whilst the lower layer is preferably amorphous silica. The thickness of each of the upper and lower layers is said to be in the range 10 to 60 μm and the examples provide a laydown of pigment in the lower layer of 18 g/m² and in the upper layer of 20 g/m².

U.S. Pat. No. 6,770,336 (Wang et al) describes an inkjet receiver having a base layer of at least 50% inorganic particles and an image-receiving layer comprising colloidal inorganics and specified mordant. The formulation is said to provide a glossy inkjet recording element that when printed with dye-based inks, provides good surface gloss, fast drying time and excellent image fastness. The base layer inorganic particles can be a number of inorganic particle types including calcium carbonate and the colloidal inorganics in the image-receiving layer are preferably selected from fumed alumina, fumed silica, silica and hydrous aluminium oxide with colloidal silica being exemplified.

US-A-2005/0179759 (Yoshida et al) describes a glossy, cast-coated, two layer inkjet receiver in which the top layer is a mixture of alumina and silica blended in the proportion 95:5 to 50:50 and coated in an amount of from 5 to 30 g/m², whilst the lower layer comprises a mixture of synthetic amorphous silica and ground calcium carbonate in a ratio of from 50:50 to 80:20 and is coated in an amount of from 4 to 20 g/m².

US-A-2004/0152819 (Cuch) describes an inkjet recording material which demonstrates a glossiness similar to that of cast-coated papers whilst having an excellent dry-time and good printability. The inkjet recording material described has at least two layers or coats, each of which contains a mixture of silica with a fumed metal oxide, the undercoat containing 0 to 20% silica and the overcoat containing 20 to 99% silica. Suitable fumed metal oxides include fumed alumina, titania, antimony (III) oxide, germanium (IV) oxide, tungsten (VI) oxide and blends thereof, the preferred fumed metal oxide being fumed alumina. Smoothing layers, comprising one of a range of pigment particle types, may be included to modify surface pH and coated onto the support prior to the ink-receiving layers. The preferred smoothing layer is a silica/calcium carbonate composition.

US-A-2004/0033323 (Gaynor et al) describes a microporous photo glossy inkjet recording media in which an absorbent base layer and an ink-receptive topcoat is composed of alumina hydrate, gelatine and a cationic polymer. The base coat comprises an absorbent pigment such as metal oxides, natural and synthetic silicates (up to 60% silica), optionally in combination with deformable hollow core-shell polymeric pigment particles, the base coat being present in an amount of up to 30 g/m².

JP2003291511 describes a sheet for inkjet recording in which at least two colouring-material receiving layers containing inorganic fine particles are provided on a support, wherein the receiving layer is constituted such that a layer in which vapour phase process silica is used as the inorganic fine particles, and a layer in which vapour phase process alumina is used as the inorganic fine particles are laminated.

It would be desirable to provide an inkjet receiver that is capable of being adapted during manufacture for use with either or both dye- or pigment-based inks and which is economical, slim, glossy, rapidly absorbing and more simple to manufacture than prior art receivers.

### Problem to be Solved by the Invention

It is an object of the invention to provide a porous inkjet receiver suitable for receiving pigmented inks and having imaging properties at least as good as commercially available photo-image porous receivers, such as an alumina receiver, but having improved manufacturability and lower cost.

It is further an object of the invention to provide a method of manufacturing an inkjet receiver that is easily adaptable for providing a universal receiver.

It has been found by the present inventor that the performance characteristics of a porous alumina inkjet receiver is equalled or improved upon at a lower cost by combining with a thin alumina-containing layer a fumed silica layer and optionally a calcium carbonate underlayer, whilst minimising difficulties in manufacturing and propensity to cracking.

### SUMMARY OF THE INVENTION

Accordingly, in a first aspect of the invention, there is provided an inkjet receiver having a support, upon which is provided an ink-receiving pack, said ink-receiving pack comprising a first, image-receiving, layer comprising a first inorganic particulate material in a dry weight amount of from 0.5 to 10 g/m², of which first inorganic particulate material at least 70% by weight is alumina, and a binder; and a second layer, located between the first layer and the support, said second layer comprising a second inorganic particulate material in a dry weight amount of from 10 to 40 g/m², of which second inorganic particulate material at least 65% is fumed silica, silica gel or a mixture thereof, and a binder.

In a second aspect of the invention, there is provided a method of manufacturing an inkjet receiver as defined above, said method comprising coating a second formulation onto a support to form a second layer on said support, said second coating formulation comprising an aqueous dispersion of a second inorganic particulate material and a binder, said second inorganic particulate material being coated in an amount of from 10 to 40 g/m², of which at least 65% is fumed silica, silica gel or a mixture thereof, and coating onto said second layer a first coating formulation to form a first layer above said second layer, said first coating formulation comprising an aqueous dispersion of a first inorganic particulate material and a binder, said first inorganic particulate material being coated in an amount of from 0.5 to 10 g/m², of which at least 70% is alumina; and drying the coated support, wherein the first and second coating formulations are coated onto the support simultaneously or sequentially.

In a third aspect of the invention, there is provided a method of printing, said method comprising the steps of providing an inkjet printer capable of responding to digital data signals, providing said printer with ink, providing the printer with an inkjet receiver as defined above and causing a set of digital data signals corresponding to a desired printed image to be sent to said printer.

In a fourth aspect of the invention, there is provided a printed receiver comprising an image printed onto a receiver as defined above by the method described above.

### ADVANTAGEOUS EFFECT OF THE INVENTION

The inkjet receiver according to the invention is capable of achieving a high rate of absorption, of exhibiting high gloss and excellent image density, whilst at the same time being relatively simple and efficient to manufacture. The inkjet receiver is also much slimmer than prior porous inkjet receivers having similar imaging properties.

The inkjet receiver of the invention is capable of providing the desired absorption rates and printing performance without exhibiting the problems of cracking often associated with alumina image-receivers.

Advantageously, an inkjet receiver of the invention is adaptable during manufacture for use either as a dye-based ink receiver or as a universal receiver, i.e. a dye- or pigment-based ink receiver.

### DETAILED DESCRIPTION OF THE INVENTION

The inkjet receiver of the present invention, which has excellent printing and absorption characteristics, comprises a support having thereon an ink-receiving pack. The ink receiving pack comprises at least a first, image-receiving, layer comprising a first inorganic particulate material and a binder and a second layer, located between the support and the first layer, which second layer comprises a second inorganic particulate material and a binder. The first inorganic particulate material is present in a dry weight amount of from 0.5 to 10 g/m² and is made up of at least 70% by weight of alumina, preferably fumed alumina. The second inorganic particulate material is present in a dry weight amount of from 10 to 40 g/m² and is made up of at least 65% of silica, which may be fumed silica, silica gel or a mixture of fumed silica and silica gel. Preferably, the total inorganic particulate material content, by which it is meant silica, (fumed) alumina and any other inorganic particulate or pigment materials present in the first, second or any other layers, in the ink-receiving pack of the inkjet receiver is in the range of from 20 to 80 g/m² dry weight. Preferably, the ink-receiving pack comprises a total inorganic particulate material dry weight laydown of from 30 to 60 g/m² and more preferably from 40 to 50 g/m².

The inkjet receiver of the invention provides a high performance, porous receiver in a relatively thin pack.

In a preferred embodiment, the first, image-receiving, layer has a thickness in the range of from 0.5 to 10 μm, preferably 2 to 8 μm and more preferably 3 to 4.5 μm. Preferably the second layer has a thickness in the range from 15 to 75 μm, preferably 25 to 50 μm, more preferably 32 to 35 μm.

Furthermore, by having an ink-receiving pack comprising a thin fumed alumina layer as the first, image-receiving, layer, and at least one under-layer, specifically a second layer comprising fumed silica and/or silica gel, the inkjet receiver according to the invention has a glossy surface and sufficient capacity and absorption rate without the expense and manufacturability issues, such as cracking, associated with thick alumina image-receiving layers.

Optionally, the first, image-receiving, layer comprises a mordant material. Preferably the mordant material is present in the image-receiving layer in an amount relative to the fumed alumina such that the inkjet receiver is capable of delivering good printing and imaging performance regardless of whether printing is carried out with a dye-based ink or a pigment-based ink, i.e. the inkjet receiver is a universal receiver. Preferably, the image-receiving layer comprises a mordant material in a dry weight ratio to the first inorganic particulate material of from 10:90 to 30:70, more preferably from 15:85 to 25:75 and most preferably about 20:80. Preferably, the mordant is present in an amount of from 0.2 to 1.5 g/m², more preferably 0.4 to 1 g/m² and most preferably 0.5 to 0.8 g/m².

By including a mordant material, the inkjet receiver is capable of receiving dye-based inks and retaining the dyes in the image-receiving layer. By utilising the mordant in the image-receiving layer in a suitable amount, the inkjet receiver can be used universally with any inkjet printing ink, whether dye-based or pigment-based. This is a major advantage of this embodiment of the inkjet receiver of the present invention over commercially available porous or non-porous receivers.

According to a preferred embodiment of the invention, the ink-receiving pack further comprises a third layer, located between the second layer and the support, which third layer comprises a binder and a third inorganic particulate material or mixture of inorganic particulate materials in a dry weight amount of from 10 to 30 g/m².

The third layer, when present, has a preferred thickness of from 10 to 30 μm, preferably 20 to 30 μm, more preferably 20 to 25 μm.

The support may be any support, preferably non resin-coated support, suitable for use in an inkjet receiver, such as plain or calendared paper, acetate, polyethylene terephthalate (PET), a printing plate support, aluminium foil, latex-treated polyester, microporous materials such as Teslin® (available from PPG Industries, Inc) or Tyvek® synthetic paper (available from Du Pont) or any other suitable support. Other suitable supports might include clear films, such as cellulose esters, including cellulose triacetate, cellulose acetate, cellulose proprionate or cellulose acetate butyrate, polyesters, polyimides, polycarbonates, polyamides, polyolefins, poly(vinyl acetals), polyethers, polyvinyl chloride, and polysulfonamides. Preferably the support is non resin-coated paper (plain or calendared).

The support used may be of any suitable thickness, such as, for example from 50 to 500 μm, or preferably from 75 to 300 μm. Antioxidants, antistatic agents, plasticizers or other known additives may be incorporated into the support, if desired.

The ink-receiving pack comprises one or more image-receiving layers (typically one image-receiving layer) and further layers which are involved in the ink-receiving process, such as those intended to absorb the carrier fluid of the ink or provide capacity (i.e. a sump) or to increase the draw or rate of uptake of ink on the surface of the receiver. Typically, the ink-receiving pack comprises the image-receiving layer(s) and the liquid absorbing layers and any intermediate layers. In the present invention, the ink-receiving pack comprises at least a first, image-receiving, layer, a second layer and optionally a third layer.

The first, image-receiving, layer comprises the first inorganic particulate material in a dry weight amount of from 0.5 to 10 g/m², preferably from 1 to 5 g/m², still more preferably from 2.5 to 4 g/m² and most preferably about 3 g/m². Whilst the first inorganic particulate material in the first layer may be a mixture of alumina and another inorganic material, it is preferably at least 75% alumina, more preferably at least 80% alumina, still more preferably at least 90% alumina, yet more preferably greater than or equal to 95% alumina and most preferably the first inorganic particulate material consists essentially of alumina. The alumina may be one or more forms of alumina, such as, for example, porous alumina, amorphous alumina, boehmite (such as a pseudo-boehmite modified with rare earths as described in U.S. Pat. No. 6,256,419, the disclosure of which is incorporated herein by reference), alumina hydrate particles, alumina hydrate surface-coated particles (e.g. alumina hydrate surface coated silica particles) or fumed alumina. Preferably, the alumina is fumed alumina. Specific examples of fumed alumina useful in the inkjet receiver described herein include those available from Cabot Corporation under the trade name CAB-O-SPERSE™ PG003 or PG008.

The first, image-receiving, layer also comprises a binder. The binder may be present in an amount of from 0.5 to 25% by dry weight of the first layer, preferably from 0.5 to 10%, more preferably from 1 to 5% and still more preferably from 1.5 to 3%.

The binder may be any suitable material for binding alumina in an inkjet receiver layer. Suitable such binders may be selected, for example, from one or more of naturally occurring hydrophilic colloids and gums such as gelatin, albumin, guar, xantham, acacia and chitosan and their derivatives, functionalised proteins, functionalised gums and starches, cellulose ethers and their derivatives, such as hydroxyethyl cellulose, hydroxypropyl cellulose and carboxymethyl cellulose, latex polymers such as styrene butadiene latex and styrene acrylate latex, polyvinyl oxazoline and polyvinyl methyloxazoline, polyoxides, polyethers, poly(ethylene imine), poly(acrylic acid), poly(methacrylic acid), n-vinyl amides including polyacrylamide and polyvinyl pyrrolidone, polyethylene oxide and polyvinyl alcohol, its derivatives and copolymers. Preferably, the binder is a polyvinyl alcohol.

Optionally, as mentioned above, the first layer may comprise a mordant. The mordant may be any suitable mordant and may be any one or more of, for example, a cationic polymer, e.g. a polymeric quartemary ammonium compound, or a basic polymer, such as poly(dimethylaminoethyl)methacrylate, polyalkylenepolyamines, and products of the condensation thereof with dicyanodiamide, amine-epichlorohydrin polycondensates, divalent Group 11 metal ions, lecithin and phospholipid compounds or any suitable mordant that is capable of assisting with fixing a dye material transferred to it. Examples of such mordants include vinylbenzyl trimethyl ammonium chloride/ethylene glycol dimethacrylate, poly(diallyl dimethyl ammonium chloride), poly(2-N,N,N-tri-methylammonium)ethyl methacrylate methosulfate, poly(3-N,N,N-trimethyl-ammonium)propyl chloride. A preferred mordant is a quarternary ammonium compound, such as, for example, a polymer of (m- and p-chloromethyl)ethenyl-benzene and 2-methyl-2-propenoic acid 1,2-ethanediylester, quaternized with N,N-dimethylmethanamine.

The first layer may, optionally, further comprise an amorphous hydrated aluminosilicate, such as an allophane, for the reduction of smearing of an image when a printed receiver is stored at high temperatures and humidities.

The first layer may also include a surfactant, added, for example, to improve the coatability of the coating composition. Suitable surfactants, depending upon the coating method used, include fluorosurfactants such as Lodyne® S100 or Zonyl® FSN, or a non-fluoro surfactants such as Olin® 10G.

Optionally, in addition to the use of alumina in the first layer, one or more fumed metallic oxide particulate materials may be employed, such as fumed titania, antimony (III) oxide, germanium (IV) oxide, tungsten (VI) oxide and blends thereof. However, for optimum performance, alumina, preferably fumed alumina, is the only such metallic oxide particulate material utilised.

The second layer comprises the second inorganic particulate material in a dry weight amount of from 10 to 40 g/m², preferably 15 to 25 g/m² and more preferably about 17 g/m². The second inorganic particulate material comprises at least 65% fumed and/or silica gel, preferably fumed silica. Whilst the second inorganic particulate material in the second layer may be a mixture of fumed silica and/or silica gel and another inorganic material, such as alumina or another silica gel or colloidal silica, it is preferably at least 75% fumed silica and/or silica gel, more preferably at least 85% fumed silica and/or silica gel, still more preferably at least 90% fumed silica and/or silica gel, yet more preferably at least 95% fumed silica and/or silica gel and most preferably the second inorganic particulate material consists essentially of fumed silica.

Without being bound by theory, it is believed that a second layer that is largely fumed silica or silica gel will provide the relatively thin alumina layer with better ink uptake in terms of absorption rate, and also in terms of capacity of the second layer for a given thickness.

The binder in the second layer may be any suitable binder and may be selected from one or more of those listed in respect of the first layer, but is preferably polyvinyl alcohol. Binder may be present in the second layer in an amount suitable to bind a fumed silica and/or silica gel in an intermediate layer of an inkjet receiver. Preferably, however, the binder in the second layer is present in an amount of from 2 to 20% by dry weight of the second layer, more preferably from 5 to 15% and most preferably from 7 to 10%.

Optionally, surfactants similar to those referred to above may be added to the second layer to aid coating.

As mentioned above, the ink-receiving pack of the inkjet receiver preferably has a third layer which comprises a third inorganic particulate material or mixture of inorganic particulate materials in a dry weight amount of from 10 to 30 g/m², preferably 20 to 30 g/m² and most preferably about 25 g/m². The third inorganic particulate material may be selected, for example, from one or more of silica (e.g. colloidal silica, synthetic amorphous silica, fumed silica or silica gel), alumina (e.g. alumina sols, colloidal alumina, cationic aluminium oxide or hydrates thereof, pseudo-boehmite, etc.), surface-treated cationic colloidal silica, magnesium silicate, aluminium silicate, magnesium carbonate, kaolin, talc, calcium sulfate, barium sulfate, titanium dioxide, zinc oxide, zinc sulfide, zinc carbonate, satin white, diatomaceous earth, clays, calcium silicate, aluminium hydroxide, lithopone, zeolite(s) (such as molecular sieves 3A, 4A, 5A and 13X), hydrated hallocyte, magnesium hydroxide and calcium carbonates (ground and/or precipitated). Organic white pigment particulate materials, such as styrene plastics pigment, acrylic plastics pigment, polyethylene, microcapsules, urea resin and melamine resin, may be used instead of or in addition to the third inorganic particulate material, but inorganic particulate materials are preferred.

Preferably, the third inorganic particulate material comprises less than 20% of an alumina or a silica, more preferably less than 10% of an alumina or a silica and most preferably is substantially free of alumina. The preferred third inorganic particulate material comprises one or a mixture of one or more calcium carbonates, which preferably make up at least 50% by weight of the third inorganic particulate material, more preferably at least 70%, still more preferably at least 80% or 85% and most preferably at least 90%.

The binder in the third layer may be any suitable binder and may be selected from one or more of those listed above in respect of the first layer, but is preferably polyvinyl alcohol. The binder may be present in the second layer in an amount suitable to bind, e.g. a calcium carbonate layer, but is preferably kept relatively low to improve the liquid communication between the second and third layers. Preferably, the binder in the third layer is present in an amount of from 0.5 to 15% by dry weight of the third layer, more preferably from 1 to 8%, still more preferably from 2 to 6% and most preferably about 4%.

As a preferred option, in order to help improve the binding in the third layer and to improve the gloss of the inkjet receiver, whilst having a minimal effect on porosity of the third layer and maintaining a liquid communication between the third and adjacent layers, the binder in the third layer comprises a mixture of non-polymer latex binder such as PVA and a polymer latex binder, such as a styrene butadiene latex. Preferably, the polymer latex binder is present in an amount similar to that of the binder, e.g. within 50% by weight of the amount of non-polymer latex binder, e.g. within 20%.

Optionally, the third layer may further comprise a silica gel in an amount of from 2 to 20% by weight of the total laydown of the third layer, more preferably from about 2 to 10% and still more preferably about 5%. In a most preferred embodiment, the third inorganic particulate material is a mixture of one or more calcium carbonates and silica in a dry weight ratio in the range of calcium carbonate to silica of from 98:2 to 80:20, preferably from 98:2 to 90:10 and more preferably in a ratio of 95:5.

The third layer may also comprise a cross-linker in an amount of about 2% by dry weight of the third layer.

The ink-receiving pack may comprises interlayers between the first, second and/or third layers. However, whilst one or more interlayers may be included in the ink-receiving pack, it is preferable for the optimum performance of the receiver that the first and second layers are adjacent to one another and/or that the third layer is adjacent the second layer. Most preferably, the ink-receiving pack consists essentially of the first, second and third layers described.

Preferably the inorganic particulate content in the first, second and third layers respectively is in the range of 1 to 5 g/m², 15 to 25 g/m² and 20 to 30 g/m² respectively.

Preferably the first, second and third inorganic particulate materials are different from one another.

In a preferred embodiment of the invention, the inkjet receiver comprises a subbing layer between the support and the ink-receiving pack. The subbing layer is preferably coated onto the support prior to coating the lowest layer of the ink-receiving pack, e.g. the subbing layer may be coated in a separate pass of a coating station to that of the ink-receiving pack. The subbing layer may be adjacent to the lowest layer of the ink-receiving pack or may be separated by one or more interlayers.

The subbing layer, which improves the adhesion of the underlayer of the ink-receiving pack to the support, typically comprises a polymer material, such as sulfonated polyesters, gelatin, poly(vinyl pyrrolidone), cellulose ethers and their derivatives such as methyl cellulose, capable of improving the adhesion of the under layer of the ink-receiving pack to the support. Preferably the subbing layer comprises a boric acid, borate or derivative and/or salt thereof. Suitable boric acid, borates and derivatives and/or salts thereof include sodium borates, derivatives of boric acid, boric anhydride and the like. A particularly preferred borate is sodium tetraborate decahydrate, which is available from Borax Limited under the trade name Borax® Decahydrate.

The subbing layer preferably comprises a polymer that does not substantially react with the boric acid, borate or a derivative or salt thereof, and more preferably does not cross-link with the boric acid, borate or a derivative or salt thereof at all. Examples of suitable such polymers include sulfonated polyesters, gelatin, poly(vinyl pyrrolidone), cellulose ethers and their derivatives such as methyl cellulose, most preferably a sulfopolyester, which is available from Eastman Chemical Company under the trade name Eastek® 1400.

The total dry laydown of material in the subbing layer is preferably in the range 0.5 to 3 g/m², more preferably 1.5 to 2.5 g/m².

Optional additional components for inclusion in the subbing layer include surfactants, for facilitating coating of the subbing layer onto the support.

The relative amounts of boric acid, borate or a derivative or salt thereof, and polymer in the subbing layer may be adjusted as desired, with regard, for example, to beneficial properties such as improved gloss with high ink-absorption rate and excellent printing properties and image density as described in our International Patent Application No. PCT/GB2005/02560 (Publication No. WO 2006/003391) filed on 30 Jun. 2005, the content of which is incorporated herein by reference, and are preferably present in a weight for weight ratio of polymer to boric acid, borate, or a derivative or salt thereof, of from 80:20 to 40:60, more preferably from 75:25 to 60:40 and still more preferably about 70:30.

The dry laydown of the boric acid, borate, or a derivative or salt thereof, is preferably varied, depending upon the amount of binder present in the preferably adjacent underlayer such that, for example, the weight for weight ratio of binder in the underlayer to boric acid, borate, or a derivative or salt thereof, in the subbing layer is from 20:1 to 1:1, more preferably 5:1 to 3:1 and most preferably about 4:1.

An inkjet receiver of the present invention may be manufactured by coating the ink-receiving pack and any optional further layers, such as the subbing layer onto the support by any suitable process known in the art. In order to improve the adhesion of the ink-receiving pack and optional further layers to the support, the surface of the support may optionally be subjected to a corona discharge treatment prior to applying the coatings.

The coating compositions, which may be aqueous- or solvent-based dispersions but are preferably aqueous dispersions of the components that go to make the desired layers, may be applied by any suitable technique, such as, for example, dip-coating, wound-wire rod-coating, doctor blade-coating, rod-coating, air knife-coating, gravure- and reverse-roll-coating, slide-coating, bead-coating, extrusion-coating, curtain-coating and the like. Preferably an extrusion-coating or curtain-coating technique is used and more preferably extrusion-coating.

In the coating process, any optional subbing layer is preferably first coated onto the support and dried and then the layers of ink-receiving pack coated simultaneously or sequentially onto the optionally coated support. Where there are two layers in the ink-receiving pack, the two layers may be coated sequentially with drying of the second layer prior to coating the first layer or may be coated simultaneously. A third or subsequent layer of the ink-receiving pack may be coated prior to the upper layers or simultaneous with the second or second and first layers.

The invention is capable of providing, by appropriate selection of the relative amounts of inorganic particulate materials in the first, second and third layers, improved Dₘᵢₙ (unprinted) gloss and improved imaging and printing properties such as improved gloss, ink-absorption and printing densities. For example, appropriate selection provides a Dₘᵢₙ gloss at 60° of greater than or equal to 55. Similarly, for example, appropriate selection provides a 60° printed gloss of greater than or equal to 60, preferably greater than or equal to 70 and more preferably greater than or equal to 75. Similarly, by selecting appropriate relative amounts of binder and inorganic particulate material in each layer, the ink-receiver according to the invention is capable of providing absorbing characteristics such that measured coalescence is less than or equal to 25, more preferably less than or equal to 20, still more preferably less than or equal to 15 and most preferably less than or equal to 10, where a coalescence of less than or equal to 10 is considered as providing excellent image quality.

The inkjet receiver of the present invention may be used with pigment-based inks and/or, when a mordant is included in the first layer, dye-based inks. By appropriate selection of the layers of the ink-receiving pack in the manner described above, good print density with both pigment- and dye-based inks is achievable.

The invention will now be described in detail, without limitation as to the scope of the invention, according to the following examples.

### EXAMPLES

### Example 1

A non resin-coated paper support was coated with four layers—a subbing layer and a three layer ink-receiving pack having an underlayer (third layer), a middle layer (second layer) and a top layer (first, ink-receiving, layer), using four different passes through a coating track.

For coating A (invention), the subbing layer was applied to the support in the first pass through the coating track. This consisted of a 70/30 mix of an aqueous dispersion of a sulfopolyester (Eastek® 1400) and Borax® Decahydrate (sodium tetraborate decahydrate). The Borax® was coated at a laydown of 0.667 g/m² and the sulfopolyester was coated at a laydown of 1.556 g/m². This layer was coated on a bead-coating machine using a slide-over extrusion hopper to assist with adhesion to the substrate.

In the second pass through the coating track, the third layer was applied on top of the subbing layer. The third layer next to the subbing layer contained a combination of two calcium carbonates (Albaglos™ S and Albacar™ HO40, both supplied by Specialty Minerals), silica gel (Gasil™ IJ-624 supplied by Ineos Silicas), a styrene butadiene latex (DL-945 supplied by Dow Chemical Company) and PVA (Gohsenol® GH17 supplied by British Traders) as a binder. Glyoxal™ was included as a cross-linker. The total dry laydown of this layer was 25.5 g/m² with the ratio of Albaglos™ S/Albacar™ HO40/IJ-624/DL-945/PVA/-Glyoxal™ coated at 35/54/5/2/2/2. Two surfactants (TX200E and Olin® 10G) were added as required to aid coating.

In the third pass through the coating track, the second layer was applied on top of the third layer. The second layer contained fumed silica (Cab-O-Sperse® PG002 supplied by Cabot Corp) and PVA (Gohsenol® GH17 supplied by British Traders) as a binder. The total dry laydown of this layer was 17.1 g/m² with the silica/PVA ratio of 92/8. Two surfactants (TX200E and Olin® 10G) were added as required to aid coating.

In the fourth and final pass through the coating track, the first (ink-receiving) layer was applied over the second layer. The first layer contained fumed alumina (Cab-O-Sperse® PG008 supplied by Cabot Corp), PVA (Gohsenol® GH17 supplied by British Traders) as a binder and a cationic polymer polymer of (m and p chloromethyl)ethenylbenzene and 2-methyl-2-propenoic acid 1,2-ethanediylester, quaternized with N,N-dimethylmethanamine) was added as a mordant. The total dry laydown of this layer was 3.1 g/m², with the fumed alumina/PVA/mordant ratio of 78/2/20. Surfactant (Zonyl® FSN) was added as required to aid coating.

As a comparison, Kodak® Professional Inkjet Photo Paper (control) was used. The formulation of this product is based on alumina and has a total coated laydown of approx 52 g/m².

It is well understood that alumina is considerably more expensive as a component compared to silica, which in turn is more expensive than inorganic pigments such as calcium carbonate. As the coating of this invention (coating A) comprises a sump layer of calcium carbonate (very inexpensive), with a mid layer comprising fumed silica (less expensive than fumed alumina) and only has a very thin top layer comprising fumed alumina, it can be seen that a low cost inkjet receiver could be produced by this means. In comparison, the Kodak® Professional Inkjet Photo Paper consists of entirely alumina and would therefore be considerably more expensive.

The coating of this invention (coating A) also has a significantly lower total laydown (total laydown of bottom, mid and top layers=45.7 g/m²) compared to the Kodak® Professional Inkjet Photo Paper, resulting in easier manufacture of the product.

### Example 2

Images were printed onto coating A (the invention) and Kodak® Professional Inkjet Photo Paper (control) using the Epson® PX-G900 (pigmented-based inks). Printed densities were then measured using an X-rite™ densitometer. Printed 60° gloss was measured using a Sheen Instruments Ltd, 160 Tri-Micro-gloss meter. Image quality (coalescence) was measured and the ink laydown at which puddling was first observed was noted.

TABLE 1
Epson PX-G900 printed densities, printed gloss and image quality

| | Printed Density | | | 60° | | Puddling |
|---|---|---|---|---|---|---|
| | | Avg | Avg | Printed | | Begins at |
| Coating | Black | R, G, B | C, M, Y | Gloss | Coalescence | (ml/m²) |
| A | 2.01 | 1.44 | 1.30 | 75.5 | 7.45 | 29.6 |
| Control | 1.98 | 1.54 | 1.46 | 78.5 | 21.60 | 16.0 |

The data in TABLE 1 indicate that the coating of this invention (coating A) gave similar printed densities and gloss to the control when printing with pigmented inks but had significantly better image quality (as shown by lower coalescence). The coating of this invention (coating A) also exhibited higher absorption capacity as ink puddling began at a much higher ink laydown compared to the control, even though the total coating laydown of coating A was considerably less than the control.

### Example 3

Images were printed onto coating A (the invention) and Kodak® Professional Inkjet Photo Paper (control) using the HP5650 printer and inkset (dye-based inks). Printed densities were then measured using an X-rite™ densitometer

TABLE 2
HP5650 printed densities

| | HP5650 Printed Density | | |
|---|---|---|---|
| Coating | Black | Avg R, G &B | Avg C, M &Y |
| A | 1.80 | 1.39 | 1.37 |
| Control | 1.66 | 1.38 | 1.40 |

The data in TABLE 2 indicate excellent printed densities (equal to the control) can be achieved with coating A when printing with dye-based inks.

These examples demonstrate that by coating an inexpensive sump layer, with a middle layer comprising fumed silica and only using a thin top layer of fumed alumina, a low cost universal receiver can be obtained which has increased capacity and better image quality (when using pigmented inks) compared to the control, whilst maintaining acceptable printed densities and gloss.

To achieve similar capacity with a product made entirely from alumina, significantly higher laydowns would be required, resulting in higher costs as well as difficulties during manufacture.

The entire contents of the patent and publications referred to in this specification are incorporated herein by reference.

The invention has been described in detail with particular reference to preferred embodiments thereof but it will be understood that variations and modifications can be effected within the spirit and scope of the invention

1. An inkjet receiver having
a support, upon which is provided an ink-receiving pack, said ink-receiving pack comprising
a first, image-receiving, layer comprising a first inorganic particulate material in a dry weight amount of from 0.5 to 10 g/m², of which said first inorganic particulate material at least 70% by weight is alumina, and a first binder; and
a second layer, located between said first layer and said support, said second layer comprising a second inorganic particulate material in a dry weight amount of from 10 to 40 g/m², of which said second inorganic particulate material at least 65% is fumed silica, silica gel or a mixture thereof, and a second binder.

2. (canceled)

3. (canceled)

4. An inkjet receiver as claimed in claim 1, wherein said first layer comprises said first inorganic particulate material in a dry weight amount of from 1 to 5 g/m².

5. An inkjet receiver as claimed in claim 1, wherein the thickness of said first layer is from 2 to 8 μm.

6. An inkjet receiver as claimed in claim 1, wherein said ink-receiving pack comprises a third layer, located between said second layer and said, support, said third layer comprising a third binder and a third inorganic particulate material or mixture of inorganic particulate materials, being present in a dry weight amount of from 10 to 30 g/m².

7. An inkjet receiver as claimed in claim 6, wherein the ink-receiving pack comprises a total dry weight amount of inorganic particulate material of from 20 to 80 g/m².

8. An inkjet receiver as claimed in claim 1, wherein said second layer comprises fumed silica in a dry weight amount of from 15 to 25 g/m².

9. An inkjet receiver as claimed in claim 6, wherein said third inorganic particulate material comprises greater than or equal to 50% by weight of one or more calcium carbonates.

10. (canceled)

11. An inkjet receiver as claimed in claim 9 wherein said third inorganic particulate material comprises a blend of calcium carbonate and a silica in a dry weight ratio of from 98:2 to 90:10.

12. An inkjet receiver as claimed in claim 1, wherein said first inorganic particulate material comprises greater than or equal to 95% alumina.

13. An inkjet receiver as claimed in claim 12, wherein said alumina is filmed alumina.

14. An inkjet receiver as claimed in claim 1, wherein said second inorganic particulate material comprises greater than or equal to 85% fumed silica and/or silica gel.

15. An inkjet receiver as claimed in claim 1, wherein said first binder in said first layer is present in an amount of 0.5 to 10% of said dry weight of said layer, said second binder in said second layer is present in an amount of 5 to 15% of said dry weight of said layer and said third binder in said third layer, when present, is in an amount of 1 to 8% of said dry weight of said layer.

16. An inkjet receiver as claimed in claim 15, wherein said first and second binders in said-first and second layers is polyvinyl alcohol and said third binder in said, optional, third layer is a mixture of polyvinyl alcohol and a latex polymer binder.

17. An inkjet receiver as claimed in claim 1, wherein said first layer further comprises a mordant in an amount relative to said first inorganic particulate material of from 10:90 to 30:70 by dry weight.

18. An inkjet receiver as claimed in claim 1, which further comprises a subbing layer located between said ink-receiving pack and said support, said subbing layer comprising a boric acid, borate, or a derivative or salt thereof and a polymer material in a total dry laydown of from 0.5 to 3 g/m².

19. (canceled)

20. An inkjet receiver as claimed in claim 1, which comprises
a support, upon which is provided an ink-receiving pack, said ink-receiving pack comprising
a first, image-receiving, layer comprising a first inorganic particulate material in a dry weight amount of from 1 to 5 g/m², of which said first inorganic particulate material at least 95% by weight is alumina, and a first binder; and
a second layer, located between said first layer and said support, said second layer comprising a second inorganic particulate material in a dry weight amount of from 15 to 25 g/m², of which said second inorganic particulate material at least 65% is filmed silica, silica gel or a mixture thereof, and a second binder; and
a third layer located between said second layer and said support, said third layer comprising a third inorganic particulate material in a dry weight amount of from 20 to 30 g/m², of which said third inorganic particulate material at least 50% is calcium carbonate

21. A method of manufacturing an inkjet receiver having
a support, upon which is provided an ink-receiving pack, said ink-receiving pack comprising
a first, image-receiving, layer comprising a first inorganic particulate material in a dry weight amount of from 0.5 to 10 g/m², of which said first inorganic particulate material at least 70% by weight is alumina, and a first binder; and a second layer, located between said first layer and said support, said second layer comprising a second inorganic particulate material in a dry weight amount of from 10 to 40 g/m², of which said second inorganic particulate material at least 65% is fumed silica, silica gel or a mixture thereof, and a second binder
said method comprising
coating a second coating formulation onto said support to form said second layer on said support, said second coating formulation comprising an aqueous dispersion of said second inorganic particulate material and said second binder, said second inorganic particulate material being coated in an amount of from 10 to 40 g/m², of which at least 65% is fumed silica, silica gel or a mixture thereof; and
coating onto said second layer a first coating formulation to form said first layer above said second layer, said first coating formulation comprising an aqueous dispersion of said first inorganic particulate material and said second binder, said first inorganic particulate material being coated in an amount of from 0.5 to 10 g/m², of which at least 70% is alumina; and
drying the coated support,
wherein said first and second coating formulations are coated onto said support simultaneously or sequentially.

22. A method of manufacturing an inkjet receiver as claimed in claim 21, which further comprises
coating a third coating formulation onto said support to form a third layer on said support prior to coating said second layer onto said support, said third coating formulation comprising an aqueous dispersion of a third inorganic particulate material and a third binder,
wherein said second and third coating formulations are coated onto said support simultaneously or sequentially.

23. A method as claimed in claim 21, which further comprises
coating a subbing formulation onto said support and drying to form a subbing layer, prior to coating any of said first, said second or any third coating formulations onto said support.

24. A method of printing, said method comprising the steps of
providing an inkjet printer capable of responding to digital data signals;
providing said printer with ink;
providing said printer with an inkjet receiver having
a support, upon which is provided an ink-receiving pack, said ink-receiving pack comprising
a first, image-receiving, layer comprising a first inorganic particulate material in a dry weight amount of from 0.5 to 10 g/m², of which said first inorganic particulate material at least 70% by weight is alumina, and a first binder; and
a second layer, located between said first layer and said support, said second layer comprising a second inorganic particulate material in a dry weight amount of from 10 to 40 g/m² of which said second inorganic particulate material at least 65% is fumed silica, silica gel or a mixture thereof, and a second binder; and
causing a set of digital data signals corresponding to a desired printed image to be sent to said printer.

25. (canceled)

26. An inkjet printing system comprising an inkjet printer and a receiver as described in claim 1.
